(19) United States
(12) Patent Application Publication
(10) Pub. No.: US 2007/0237911 A1
(43) Pub. Date: Oct. 11, 2007

(54) Coating liquid for ink receiving layer, production method thereof, ink jet recording medium and production method thereof

(75) Inventor: Ryoichi Nakano, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/783,304

(22) Filed: Apr. 9, 2007

(30) Foreign Application Priority Data
Apr. 7, 2006 (JP) 2006-106459

(51) Int. Cl. B41M 5/50

(52) U.S. Cl. 428/32.34

(57) ABSTRACT

A production method of a coating liquid for an ink receiving layer, capable of suppressing viscosity increase of the coating liquid, a coating liquid for an ink receiving layer obtained by the method, an ink jet recording medium produced using this coating liquid, and a production method thereof.

1. A production method of a coating liquid for an ink receiving layer, the production method including: dispersing in a liquid at least silica fine particles synthesized by a gas phase method and an amino acid having only one carboxyl group per molecule, to obtain a silica dispersion; adding a water soluble binder to the silica dispersion.

### CROSS-REFERENCE TO RELATED APPLICATION

This application claims priority under 35USC119 from Japanese Patent Application No. 2006-106459, the disclosure of which is incorporated by reference herein.

### BACKGROUND OF THE INVENTION

1. Field of the Invention

The present invention relates to a coating liquid for an ink receiving layer, a production method thereof, an ink jet recording medium and a production method thereof.

2. Description of the Related Art

In recent years, with the rapid advance of the information technology industries, various information processing systems have been developed. Recording methods and devices suitable for the latest information systems have also been developed and put into practical use. Examples of such practically used recording methods include ink jet recording methods, thermosensitive recording methods, pressure sensitive recording methods, photographic methods and thermal transfer recording methods.

Among these recording methods, ink-jet recording methods have become widely used for not only in offices but also in the home. The advantages of the ink-jet recording methods are that they can be applied to a variety of recording materials, the hardware (apparatus) is relatively economical, compact and quiet.

Since resolution of ink jet printers has increased in recent years, obtaining “photorealistic” high quality recorded material has become possible, and various kinds of ink jet recording sheets have been developed along with such improvements in hardware (apparatus).

Required characteristics for these ink jet printing media are generally: (1) rapid drying (rapid ink-absorption speed), (2) proper and uniform diameter of ink dots (no bleeding), (3) good granularity, (4) high circularity of dots, (5) high color density, (6) high chroma (free of dullness), (7) good water resistance, light fastness and ozone resistance of printed portions, (8) high brightness of recording sheets, (9) good storability of recording sheets (no yellowing or bleeding of images in long term storage (excellent in prevention of bleeding over time), (10) substantially no deformation with good dimensional stability (sufficiently small curling), and (11) good runnability in the hardware.

In the use of photographic glossy paper sheets used for obtaining photorealistic high quality printed material, in addition to the various aforementioned characteristics, the recording sheets are also required to have glossiness, glossiness of printed portions, surface smoothness and texture of printed paper sheets resembling that of silver salt photographs.

An ink jet recording medium having a porous structure in an ink receiving layer has been developed, and used in practice, in recent years for improving the various characteristics described above. Such an ink jet recording medium is excellent in ink receptivity (speed of drying) while having high glossiness, due to providing the porous structure.

An ink jet recording medium with, on a substrate, an ink receiving layer that includes fine inorganic pigment particles and a water soluble resin, and that has a high void ratio, has been proposed (for example, see Japanese Patent Application Laid-Open (JP-A) Nos. 10-119423 and 10-217601).

These recording sheets, and particularly an ink jet recording medium having an ink receiving layer with a porous structure that uses silica as the fine inorganic pigment particles, are excellent in ink absorbing property due to their construction. Accordingly, the ink jet recording medium has excellent ink absorptivity and a high ink receptivity that is capable of forming a high resolution image, while the medium exhibits high glossiness.

Ink jet recording paper containing an amino acid and a divalent or higher valency water soluble metallic salt is disclosed for improving light fastness, ozone resistance and the like of images (for example, see Japanese Patent Application Laid-Open (JP-A) No. 2003-11492).

An ink receiving layer is formed by applying a coating liquid for an ink receiving layer containing inorganic fine particles and a water soluble binder onto a substrate. However, the mixing of inorganic fine particles (particularly, silica fine particles) and a water soluble binder has increased viscosity that hinders the application of a coating liquid for an ink receiving layer.

### SUMMARY OF THE INVENTION

The present invention has been made in view of the above circumstances and provides a coating liquid for an ink receiving layer, a production method thereof, an ink jet recording medium and a production method thereof. A first aspect of the present invention provides a production method of a coating liquid for an ink receiving layer, the production method including: dispersing in a liquid at least silica fine particles synthesized by a gas phase method and an amino acid having only one carboxyl group per molecule, to obtain a silica dispersion; adding a water soluble binder to the silica dispersion. A second aspect of the present invention provides coating liquid for an ink receiving layer including: a water soluble binder added to a silica dispersion obtained by dispersing at least silica fine particles synthesized by a gas phase method and an amino acid having only one carboxyl group per molecule in a liquid. A third aspect of the present invention provides a production method of an ink jet recording medium having a substrate and an ink receiving layer provided on the substrate, the production method including: dispersing at least silica fine particles synthesized by a gas phase method and an amino acid having only one carboxyl group per molecule in a liquid to form a silica dispersion; adding a water soluble binder to the silica dispersion to form a coating liquid for an ink receiving layer; and applying the coating liquid onto the substrate, forming an ink receiving coated layer. A fourth aspect of the present invention provides ink jet recording medium having a substrate and an ink receiving layer provided on the substrate, the ink jet recording medium including a coated layer formed by applying onto the substrate a coating liquid for an ink receiving layer, wherein the coating liquid includes a silica dispersion obtained by dispersing at least silica fine particles synthesized by a gas phase method and an amino acid having only one carboxyl group per molecule in a liquid, to which a water soluble binder has been added.

### DETAILED DESCRIPTION OF THE INVENTION

The present invention has been made in view of the above-mentioned conventional problem and is intended to provide a production method of a coating liquid for an ink receiving layer, capable of suppressing viscosity increase, a coating liquid for an ink receiving layer obtained by the method, an ink jet recording medium using this coating liquid, and a production method thereof.

A coating liquid for an ink receiving layer, a production method thereof, an ink jet recording medium and a production method thereof of the invention will be described in detail below.

<Coating Liquid for an Ink Receiving Layer and Production Method Thereof>

A production method of a coating liquid for an ink receiving layer of the invention is characterized in that a water soluble binder is added to silica dispersion obtained by dispersing a mixed liquid containing silica fine particles synthesized by a gas phase method (hereinafter, occasionally referred to as gas phase silica) and an amino acid having one carboxyl group in a molecule. A coating liquid for an ink receiving layer of the invention is produced by a production method of a coating liquid for an ink receiving layer of the invention.

In a production method of a coating liquid for an ink receiving layer of the invention, a water soluble binder is added to silica dispersion containing a predetermined amino acid, so that viscosity increase of the coating liquid can be suppressed. It is surmised that the reason therefor is that the amino acid is adsorbed in a surface of silica fine particles to suppress the interaction between the silica fine particles and the water soluble binder.

“Dispersion” in the invention signifies a state such that particles having a particle size of 5 μm or more do not exist in silica dispersion (confirmation can be made by no detection thereof with the use of a laser diffraction particle size analyzer and the like). Specific examples of a dispersion method include dispersion methods using conventionally known dispersers such as a high speed disperser, medium stirring disperser (for example, ball mill, sand mill and bead mill), ultrasonic disperser, colloid mill disperser and high pressure disperser.

Each component used for a coating liquid for an ink receiving layer and a production method thereof of the invention is described below.

(Silica Fine Particles)

The silica fine particles are roughly classified into wet method particles and dry method (gas phase method) particles depending on their production method. In the prevailing wet method, active silica is formed by acidolysis of a silicate salt, and active silica is appropriately polymerized to obtain hydrated silica by coagulation and precipitation. In contrast, anhydrous silica is obtained by hydrolysis of silicon halide in a gas phase at a high temperature (flame hydrolysis method), or silica sand and coke are vaporized by reduction by heating with arc in an electric furnace, and the product thereof is oxidized with air (arc method) in the prevailing gas phase method. The “gas phase silica” means anhydrous silica fine particles obtained by the gas phase method. The silica fine particles by the gas phase method are particularly preferable as the silica fine particles used in the invention.

Although the gas phase silica exhibits different properties from hydrated silica due to the difference of the density of the silanol groups on the surface and the proportion of the voids, the gas phase silica is suitable for forming a three-dimensional structure having a high void ratio. While the reason thereof is not clear, the density of the silanol groups on the surface of the fine particles is as large as 5 to 8 pieces/nm² in hydrated silica to make the silica particles to be readily aggregated. In contrast, the density of the silanol group on the surface of the fine particles is supposed to be as small as 2 to 3 groups/nm² in gas phase silica to form coarse and soft flocculates, thereby forming a structure having a high void ratio.

Since gas phase silica has a particularly large surface area, the efficiency for absorbing and retaining an ink becomes high. In addition, the ink receiving layer becomes transparent by dispersing the particles having a proper particle diameter since the refractive index of gas phase silica is low, thereby exhibiting characteristics for enabling a high color density and good coloring property to be obtained. It is important for obtaining a high color density and good glossiness of colors that the color receiving layer is transparent not only in the uses requiring high transparency such as an OHP film, but also in an application as a recording sheet such as a photographic glossy paper sheet.

The average primary particle diameter of gas phase silica is preferably 50 nm or less, more preferably 1 to 50 nm, more preferably Ito 30 nm, particularly 1 to 20 nm, and most preferably 1 to 10 nm from the view point of the fast drying characteristics of the recording sheet (ink absorbing rate). Since the gas phase silica particles are liable to be coagulated with each other due to the hydrogen bond between the silanol groups, a structure having a large void ratio may be formed when the average primary particle diameter is 50 nm or less, and ink absorbing characteristics may be effectively improved.

In the present invention, the gas phase silica fine particles may be used together with other inorganic fine particles that will be described after. The content of gas phase silica in the total fine particles is preferably 30% by mass or more, more preferably 50% by mass or more, when the gas phase silica particles are used together with other inorganic fine particles. Examples of the inorganic fine particles include colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide, and yttrium oxide.

The embodiments disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314 can be also preferably used when the fine above-mentioned particles are used in for the ink jet recording medium.

(Amino Acid)

An amino acid used for the invention can be properly selected from amino acids having one carboxyl group in a molecule, such as any type of α, β and γ. An amino acid of the invention also includes imino acids in which hydrogen in an amino group is substituted with a side chain portion in a molecule to have a ring structure (—NH—), such as proline and hydroxyproline.

Specific examples thereof include azaserine, asparagine, aminobutyric acid, alanine, arginine, alloisoleucine, allothreonine, isoleucine, ethionine, ergothioneine, ornithine, canavanine, carboxymethylcysteine, kynurenine, glycine, glutamine, creatinine, sarcosine, cystathionine, cystine, cysteine, cysteic acid, citrulline, DOPA (3,4-dihydroxyphenyl-L-alanine), 3,5-diiodotyrosine, serine, taurine, thyroxine, tyrosine, tryptophan, threonine, norvaline, norleucine, valine, histidine, 4-hydroxylycine, phenylalanine, proline, homoserine, methionine, 1-methylhistidine, lanthionine, lycine and leucine. Alkali metal salts of these amino acids can also be used.

In the invention, amino acids containing a sulfur atom are preferable, and L-cystine, methionine and methionine sulfoxide are particularly preferable.

The amount of an amino acid with respect to the total solid mass of a coating liquid for an ink receiving layer is preferably 3 to 30% by mass, more preferably 5 to 25% by mass from the viewpoint of the compatibility between suppression of viscosity increase of the coating liquid and bronze prevention.

(Water Soluble Binder)

Examples of the water soluble binder used in the invention include polyvinyl alcohol resins having hydroxyl groups as a hydrophilic structural unit (for example polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), cellulose resins (methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitin, chitosan, starch, resins having ether bonds (polyethylene oxide (PEO), polypropylene oxide (PPO), polyethyleneglycol (PEG) and polyvinyl ether (PVE)), resins having carbamoyl groups (polyacrylamide (PAAM), polyvinyl pyrrolidone (PVP) and polyacrylic acid hydrazide).

The other examples include polyacrylic acid salts, maleic acid resins, alginic acid salts and gelatin having carboxylic groups as dissociation groups.

The polyvinyl alcohol resins are particularly preferable among the resin above. Examples of the polyvinyl alcohol resins are described in Japanese Patent Application Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345 and 8-324105, 11-348417.

Examples of the water soluble resin other than the polyvinyl alcohol resins are the compounds described in paragraph Nos. 0011 to 0014 in JP-A No. 11-165461.

The water soluble resins may be used alone, or as a combination of two or more of them.

The content of the water soluble resin of the invention is preferably 9 to 40% by mass, more preferably 12 to 33% by mass, relative to the mass of total solid fraction of the coating liquid for the ink receiving layer.

The water soluble binder and fine particles mainly constituting the ink receiving layer of the invention may comprise respective single materials, or a mixed material of a plurality of materials.

The kind of the water soluble resin combined with silica fine particles, is important from the viewpoint of maintaining transparency. Polyvinyl alcohol resins are preferable as the water soluble binder when gas phase silica is used. The polyvinyl alcohol resin with a degree of saponification of 70 to 100% is more preferable, and the polyvinyl alcohol resin with a degree of saponification of 80 to 99.5% is particularly preferable.

While the polyvinyl alcohol resin has hydroxyl groups in its structural unit, a three dimensional network structure is readily formed using secondary particles of the silica fine particles as a network chain unit, since the hydroxyl group forms hydrogen bonds with the silanol group on the surface of the silica fine particles. The ink receiving layer having a porous structure with a high void ratio and sufficient strength is considered to be formed by forming the three dimensional network structure.

The porous ink receiving layer obtained as described above rapidly absorb the ink by capillary action during the ink jet recording process, and can form high circularity of dots without causing bleeding of the ink.

The polyvinyl alcohol resin may be used together with other water soluble binders. The content of the polyvinyl alcohol resin in the total water soluble binders is preferably 50% by mass or more, more preferably 70% by mass or more, when the polyvinyl alcohol resin is used together with other water soluble binders.

### <Composition Ratio of Fine Silica Particles and Water Soluble Binder>

The mass composition ratio (PB ratio (x/y)) between the proportion fine silica particles (x) and water soluble binder (y) largely affect the structure and strength of the ink receiving layer. While the void ratio, fine void volume and surface area (per unit mass) tend to increase as the mass composition ratio (PB ratio) increases, the density and strength tends to be decreased.

The mass composition ratio (PB ratio, (x/y)) of the ink receiving layer formed with the coating liquid for the ink receiving layer of the invention is preferably 1.5 to 10, for preventing decrease of the layer strength and cracks from generating by drying due to too large PB ratio, and for preventing decrease of ink absorbing ability due to blocking of voids with the resin and decrease of the void ratio when the PB ratio is too small.

Since a strain may be applied on a recording sheet when the recording sheet is conveyed in a conveyer system of an ink jet printer, the ink receiving layer should have sufficient film strength. The ink receiving layer should also have a sufficient strength for preventing cracks and peeling of the ink receiving layer from being generated when the recording sheet is cutting into smaller sheets. The mass ratio (x/y) of 5 or less is more preferable considering the cases above, and a mass ratio of 2 or more is more preferable from the viewpoint of ensuring high speed ink absorption in the ink jet printer.

The three dimensional network structure comprising the network chains of the secondary particles of the silica fine particles is formed, for example, by preparing a coating liquid in which the gas phase silica fine particles with an average primary diameter of 20 nm or less and water soluble resin are completely dispersed in water in a mass ratio (x/y) of 2 to 5, by applying the coating liquid on the substrate, and by drying the coated layer. A light-permeable porous layer with an average fine void diameter of 30 nm or less, a void ratio of 50 to 80%, a specific void volume of 0.5 ml/g or more, and a specific surface area of 100 m²/g or more may be readily formed by the procedure above.

In the invention, a cross-linking agent capable of cross-linking a water soluble binder can be further added to a coating liquid for an ink receiving layer. The addition timing of a cross-linking agent is not particularly limited, which cross-linking agent may be added to a mixed liquid, silica dispersion or both of them.

Boron compounds are preferably used for cross-linking of the water soluble binder, particularly polyvinyl alcohol resin. Examples of the boron compound include borax, boric acid, borate (for example orthoborate, InBO₃, ScBO₃, YBO₃, LaBO₃, Mg₃(BO₃)₂ and Co₃(BO₃)₂), diborate (for example Mg₂B₂O₅, Co₂B₂O₅), methaborate (for example LiBO₂, Ca(BO₂)₂, NaBO₂ and KBO₂), tetraborate (for example Na₂B₄O₇.10H₂O), and pentaborate (for example KB₅O₈.4H₂O, Ca₂B₆O₁₁.7H₂O, and CsB₅O₅). Borax, boric acid and borates are preferable for permitting the cross-linking reaction to be promptly induced, and boric acid is particularly preferable.

The following compounds other than the boron compounds may be used as the cross-linking agent of the water soluble resin.

The compounds are, for example, aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine, 2,4-dichloro-6-triazine sodium salt; active vinyl compounds such as divinyl sulfone, 1,3-divinylsulfonyl-2-propanol, N,N′-ethylenebis(vinylsulfonylacetamide), and 1,3,5-triaclyroyl-hexahydro-5-triazine; N-methylol compounds such as dimethylol urea, and methylol dimethylhydantoin; melamine resins (for example methylolmelamine, alkylated methylolmelamine; and epoxy resins.

Examples of the preferable cross-linking agent include isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid and mucophenoxy chloric acid; dioxane compounds such as 2,3-dihydroxydioxane, metal-containing compounds such as titanium lactate, aluminum sulfate, chromium alum, potassium alum, zirconium acetate and chromium acetate; polyamine compounds such as tetraethylenepentamine; hydrazide compounds such as hydrazine adipate; and low molecular weight compounds or polymers containing at least two oxazoline groups.

The above mentioned cross-linking agents may be used alone, or as a combination thereof.

The use amount of the cross-linking agent is preferably 1 to 50% by mass, and more preferably 5 to 40% by mass, relative to the amount of the water-soluble resin.

(Water Soluble Polyvalent Metallic Salt)

In the invention, a water soluble polyvalent metallic salt can be further added to a coating liquid for an ink receiving layer. The addition timing of a water soluble polyvalent metallic salt is not particularly limited, which metallic salt may be added to a mixed liquid, silica dispersion or both of them.

Examples of a water soluble polyvalent metallic compound used for the invention include water soluble salts of metals selected from calcium, barium, manganese, copper, cobalt, nickel, aluminum, iron, zinc, zirconium, chromium, magnesium, tungsten and molybdenum; a trivalent or higher metallic compound is preferable.

Specific examples thereof include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate dihydrate, manganese ammonium sulfate hexahydrate, cupric chloride, copper(II)ammonium chloride dihydrate, copper sulfate, copper(II) butyrate, copper oxalate, copper phthalate, copper citrate, copper gluconate, copper naphthenate, cobalt chloride, cobalt thiocyanate, cobalt sulfate, cobalt(II) acetate, cobalt naphthenate, nickel sulfate hexahydrate, nickel chloride hexahydrate, nickel acetate tetrahydrate, nickel ammonium sulfate hexahydrate, nickel amidosulfate tetrahydrate, nickel sulfamate, nickel 2-ethyl hexanoate, aluminum sulfate, aluminum sulfite, aluminum thiosulfate, polyaluminum chloride, aluminum nitrate nonahydrate, aluminum chloride hexahydrate, aluminum acetate, aluminum lactate, basic aluminum thioglycolate, ferrous bromide, ferrous chloride, ferric chloride, ferrous sulfate, ferric sulfate, iron(III) citrate, iron(III) lactate trihydrate, iron(III)triammonium trioxalate trihydrate, zinc bromide, zinc chloride, zinc sulfate hexahydrate, zinc sulfate, zinc acetate, zinc lactate, zirconium acetate, zirconium tetrachloride, zirconium chloride, zirconium oxychloride octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium phosphotungstate, sodium tungsten citrate, 12-tungstophosphoric acid n-hydrate, 12-tungstosilicic acid 26-hydrate, molybdenum chloride, 12-molybdophosphoric acid n-hydrate, aluminum alum, basic polyaluminum hydroxide, zinc phenolsulfonate, zinc ammonium acetate and zinc ammonium carbonate. These water soluble polyvalent metallic compounds may be used together in two kinds or more. In the invention, water solubility in a water soluble polyvalent metallic compound signifies dissolution of 1% by mass or more in water at a temperature of 20° C.

Among the above-mentioned water soluble polyvalent metallic compounds, aluminum compounds or compounds composed of metals (such as zirconium and titanium) in 4A family of the periodic table are preferable, and aluminum compounds are more preferable. Water soluble aluminum compounds are particularly preferable. Examples of water soluble aluminum compounds include aluminum chloride or hydrate thereof, aluminum sulfate or hydrate thereof, and aluminum alum as inorganic salts. In addition, basic polyaluminum hydroxide compounds as inorganic aluminum-containing cationic polymers are known and preferably used.

The above-mentioned basic polyaluminum hydroxide compounds are water soluble polyaluminum hydroxides in which the primary component is represented by the following formula 1, 2 or 3, and basic polymeric polynuclear condensation ions such as [Al₆(OH)₁₅]³⁺, [Al₈(OH)₂₀]⁴⁺, [Al₁₃(OH)₃₄]⁵⁺ and [Al₂₁(OH)₆₀]³⁺ are stably contained.

[Al₂(OH)ₙCl₆₋ₙ]ₘ 5<m<80, 1<n<5 formula 1

[Al(OH)₃]ₙAlCl₃ 1<n<2 formula 2

Alₙ(OH)ₘCl₍₃ₙ₋ₘ₎ 0<m<3n, 5<m<8 formula 3

These compounds are put on the market under the trade name of polyaluminum chloride (PAC) as a water treatment agent manufactured by Taki Chemical Co., Ltd., the trade name of polyaluminum hydroxide (Paho) manufactured by Asada Chemical Industry Co., Ltd., the trade name of HAP-25 manufactured by Rikengreen Co., Ltd. and the trade name of ALUFINE 83 manufactured by Taimei Chemicals Co., Ltd., and for the same purpose from other manufacturers; the compounds of various grades are easily available.

The above-mentioned water soluble compounds containing elements in 4A family of the periodic table are more preferably water soluble compounds containing titanium or zirconium. Examples of water soluble compounds containing titanium include titanium chloride, titanium sulfate, titanium tetrachloride, tetraisopropyl titanate, titanium acetylacetonate and titanium lactate. Examples of water soluble compounds containing zirconium include zirconium acetate, zirconium chloride, zirconium hydroxychloride, zirconium nitrate, basic zirconium carbonate, zirconium hydroxide, zirconium lactate, zirconium ammonium carbonate, zirconium potassium carbonate, zirconium sulfate and zirconium fluoride compounds.

The above-mentioned water soluble polyvalent metallic compounds are preferably added at a ratio of 0.1 to 10% by mass with respect to silica fine particles, more preferably 0.5 to 8% by mass.

(Mordant)

In the invention, a mordant can be further added to a coating liquid for an ink receiving layer. The addition timing of a mordant is not particularly limited, which mordant may be added to a mixed liquid, silica dispersion or both of them.

An ink receiving layer obtained by using a coating liquid for an ink receiving layer containing a mordant is excellent in water resistance and resistance to bleeding over time of formed images.

Such mordant is preferably a cationic polymer (cationic mordant) as an organic mordant, or an inorganic mordant. Presence of the mordant in the ink receiving layer permits colorant to be stabilized by an interaction between the mordant and a liquid ink containing an anionic dye as the colorant thereby permitting water resistance to be improved and bleeding over time to be reduced. Each of organic mordant and the inorganic mordant may be used alone, or may be used together.

Polymer mordants having primary to tertiary amino groups, or quaternary ammonium group as cationic groups are usually used as the cationic mordants. However, cationic non-polymer mordants may be also used in the invention.

Examples of the polymer mordant include homopolymers of monomers (mordant monomers) comprising the primary to tertiary amino groups and salts thereof or quaternary ammonium salts, and copolymers or condensed polymers between the dye mordant monomer and other monomers (referred to as “non-mordant monomer” hereinafter). These polymer mordants may be used either as water soluble polymers or water dispersible latex particles.

Examples of the above-mentioned monomers (mordant monomers) include trimethyl-para-vinylbenzylammonium chloride, trimethyl-meta-vinylbenzylammonium chloride, triethyl-para-vinylbenzylammonium chloride, triethyl-meta-vinylbenzylammonium chloride, N,N-dimethyl-N-ethyl-N-para-vinylbenzylammonium chloride, N,N-diethyl-N-methyl-N-para-vinylbenzylammonium chloride, N,N-dimethyl-N-n-propyl-N-para-vinylbenzylammonium chloride, N,N-dimethyl-N-n-octyl-N-para-vinylbenzylammonium chloride, N,N-dimethyl-N-benzyl-N-para-vinylbenzylammonium chloride, N,N-diethyl-N-benzyl-N-para-vinylbenzylammonium chloride, N,N-dimethyl-N-(4-methyl)benzyl-N-para-vinylbenzylammonium chloride, N,N-dimethyl-N-phenyl-N-para-vinylbenzylammonium chloride;

trimethyl-para-vinylbenzylammonium bromide, trimethyl-meta-vinylbenzylammonium bromide, trimethyl-para-vinylbenzylammonium sulfonate, trimethyl-meta-vinylbenzylammonium sulfonate, trimethyl-para-vinylbenzylammonium acetate, trimethyl-meta-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;

N,N-dimethylaminoethyl(meth)acrylate, N,N-diethylaminoethyl(meth)acrylate, N,N-dimethylaminopropyl (meth)acrylate, N,N-diethylaminopropyl(meth)acrylate, N,N-dimethylaminoethyl (meth)acrylamide, N,N-diethylaminoethyl(meth)acrylamide, N,N-dimethylaminopropyl (meth)acrylamide, N,N-diethylaminopropyl(meth)acrylamide, and salts thereof (such as hydrochloride, nitrate, acetate, lactate, methanesulfonate and para-toluenesulfonate);

trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino) ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride; N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other mordant monomer include N-vinylimidazole, N-vinyl-2-methylimidazole, 2-vinylpyridine, 4-vinylpyridine, 4-vinyl-N-methylpyridinium chloride, 4-vinyl-N-ethylpyridinium bromide, dimethyldiallylammonium chloride, and monomethyldiallylammonium chloride.

The mordant monomer may be used alone, or as a combination of copolymerizable two or more of them.

The non-mordant monomers refer to those that contain no basic or cationic portions such as primary to tertiary amino groups or quaternary ammonium salts, and that do not interact, or exhibit substantially small interaction, with dyes in an ink-jet ink.

Examples of the non-mordant monomer include alkyl(meth)acrylate (for example C 1-18 alkyl(meth)acrylate such as methyl(meth)acrylate, ethyl(meth)acrylate, propyl(meth)acrylate, isopropyl(meth)acrylate, n-butyl(meth)acrylate, isobutyl (meth)acrylate, t-butyl(meth)acrylate, hexyl(meth)acrylate, octyl(meth)acrylate, 2-ethylhexyl (meth)acrylate, lauryl(meth)acrylate and stearyl(meth)acrylate); cycloalkyl(meth)acrylate (such as cyclohexyl(meth)acrylate); aryl methacrylate (such as phenyl(meth)acrylate)); aralkyl(meth)acrylate (such as benzyl(meth)acrylate); substituted alkyl(meth)acrylate (such as 2-hydroxyethyl(meth)acrylate, methoxymethyl(meth)acrylate and allyl(meth)acrylate); (meth)acrylamides (such as (meth)acrylamide, dimethyl(meth)acrylamide, N-ethyl (meth)acrylamide, and N-isopropyl(meth)acrylamide); aromatic vinyl(styrene, vinyltoluene and α-methylstyrene); vinyl esters (such as vinyl acetate, vinyl propionate and vinyl versatate); allyl esters (such as allyl acetate); halogen-containing monomers (such as vinylidene chloride and vinyl chloride); vinyl cyanate (such as (meth)acrylonitrile); and olefins (such as ethylene and propylene).

These non-mordant monomers may be used alone, or as a combination of two or more of them.

Examples of the polymer mordant include polyethyleneimine (and derivatives thereof), polyvinylamine (and derivatives thereof), polyallyamine (and derivatives thereof), polyamidine, cationic polysaccharide (such as cationic starch and chitosan), dicyan cationic resin (such as dicyan diamide-formalin polymerization condensation products), polyamine cationic resin (such as dicyan diamide-diethylenetriamine polymerization condensation products), epichlorohydrin-dimethylamine addition polymers, and dimethyldiallylammonium chloride-sulfur dioxide copolymer.

Polymers having quaternary ammonium base are preferable, and (meth)acrylate polymers, vinylbenzylammonium polymers and diallylammonium polymers having weight average molecular weight of 1,000 to 100,000 and quaternary ammonium base are particularly preferable as the organic mordant of the invention.

The amount of the mordant included the coating liquid for the ink receiving layer of the invention is preferably 0.01 g/m² to 10 g/m², more preferably 0.1 g/m² to 5 g/m².

The ink receiving layer coating liquid preferably contains a surfactant. Any surfactants such as cationic, anionic, nonionic, amphoteric, fluorine and silicone surfactants are available.

Examples of the preferable nonionic surfactant include polyoxyalkylene alkylether and polyoxyalkylene alkylphenylether (such as diethyleneglycol monoethylether, diethyleneglycol diethylether, polyoxyethylene laurylether, polyoxyethylene stearylether and polyoxyethylene nonylphenylether); oxyethylene-oxypropylene block copolymer, sorbitan fatty acid esters (such as sorbitan monolaurate, sorbitan monooleate and sorbitan trioleate); polyoxyethylene sorbitan fatty acid esters (such as polyoxyethylene sorbitan monolaurate, polyoxyethylene sorbitan monoolelate and polyoxyethylene sorbitan trioleate); polyoxyethylene sorbitol fatty acid esters (such as tetra oleic acid polyoxyethylene sorbit); glycerin fatty acid esters (such as glycerol monooleate); polyoxyethylene glycerin fatty acid esters (such as monostearic acid polyoxyethylene glycerin and monooleic acid polyoxyethylene glycerin); polyoxyethylene fatty acid esters (such as polyethyleneglycol monolaurate, and polyethyleneglycol monooleate); polyoxyethylene alkylamine; and acetylene glycols (such as 2,4,9,7-tetramethyl-5-decyn-4,7-diol, and ethylene oxide adducts and propylene oxide adducts of the diol). Polyoxyalkylene alkylethers are preferable among them. The nonionic surfactant may also be used in a second coating liquid that will be described after. The nonionic surfactants may be used alone, or as a combination of two or more of them.

Examples of the amphoteric surfactants include those of amino acid type, carboxyamonium betaine type, sulfoammonium betaine type, ammonium sulfonic ester betaine type and imidazolium betaine type, and those described in U.S. Pat. No. 3,843,368, JP-A Nos. 59-49535, 63-236546, 5-303205, 8-262742 and 10-282619 may be favorably used. Amphoteric surfactants of the amino acid type are preferable as the amphoteric surfactant, which are derived from amino acids (such as glycine, glutamic acid and histidine) as described in JP-A No. 5-303205. An example thereof is N-aminoacyl acid in which a long chain acyl group is introduced and the salt thereof. The amphoteric surfactants may be used alone, or as a combination of at least two of them.

Examples of the anionic surfactants include fatty acid salts (for example sodium stearate and potassium oleate), salts of alkylsulfuric acid ester (for example sodium lauryl sulfate and triethanolamine lauryl sulfate), sulfonic acid slats (for example sodium dodecylbenzene sulfonate), alkylsulfosuccinic acid salts (for example sodium dioctylsulfosuccinate), alkyldiphenylether disulfonic acid salts, and alkylphosphoric acid salts.

Examples of the cationic surfactants include alkylamine salts, quaternary ammonium salts, pyridinium salts and imidazolium salts.

Examples of the fluorine containing surfactants include a compound derived via an intermediate having perfluoroalkyl groups using any one of electrolytic fluorination, teromerization and origomerization methods.

Examples of the fluorine containing surfactants include perfluoroalkyl sulfonic acid salts, perfluoroalkyl carboxylic acid salts, perfluoroalkyl ethylene oxide adducts, perfluoroalkyl trialkyl ammonium salts, perfluoroalkyl group containing oligomers, and perfluoroalkyl phosphoric acid esters.

The silicon surfactant is preferably a silicone oil modified with an organic group, which may have a structure comprising side chains of a siloxane structure modified with the organic group, a structure having modified both terminals, and a structure having a modified terminal. Examples of modification with the organic group include amino modification, polyether modification, epoxy modification, carboxyl modification, carbinol modification, alkyl modification, aralkyl modification, phenol modification and fluorine modification.

The content of the surfactant of the invention is preferably 0.01 to 2.0%, more preferably 0.01 to 1.0%, relative to the coating liquid for the ink receiving layer. When at least two coating liquids for the ink receiving layer are used for coating, it is preferable to add the surfactant to respective coating liquids.

The coating liquid for the ink receiving layer of the invention preferably contains a high boiling point organic solvent for preventing curling of the ink receiving layer. The high boiling point organic solvent is an organic compound having a boiling point of 150° C. or more at an atmospheric pressure, and a water soluble or hydrophobic compound. These solvent may be a solid or liquid at room temperature, and may be a low molecular weight or high molecular weight compound.

Examples of the organic solvent include aromatic carboxylic acid esters (such as dibutyl phthalate, diphenyl phthalate and phenyl benzoate); aliphatic carboxylic acid esters (such as dioctyl adipate, dibutyl sebacate, methyl stearate, dibutyl maleate, dibutyl fumarate and triethyl acetylcitrate); phosphoric acid esters (such as trioctyl phosphate and tricresil phosphate); epoxy compounds (such as epoxylated soy bean oil and epoxylated fatty acid methyl esters); alcohols (such as stearyl alcohol, ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-butanetriol, 1,2,4-pentanetriol, 1,2,6-hexanetriol, thiodiglycol, triethanolamine and polyethyleneglycol); vegetable oils (such as soy bean oil and sunflower oil); and higher aliphatic carboxylic acid (such as linoleic acid and oleic acid).

The solvents available in the invention are for instance water, organic solvents or mixtures thereof. The organic solvents include alcohols such as methanol, ethanol, n-propanol, i-propanol and methoxypropanol, ketones such as acetone and methylethyl ketone, tetrahydrofuran, acetonitrile, ethyl acetate and toluene. The solid content of the coating liquid for the ink receiving layer of the invention is preferably 0.1 to 5.0% by weight, more preferably 0.3 to 3.0% by weight.

The pH of the coating liquid for the ink receiving layer of the invention is not particularly restricted, it is preferably 2 or more and 6 or less, more preferably 3 or more and 5 or less. Bleeding over time of the image may be suppressed by forming the ink receiving layer from the coating liquid having a pH value of 2 or more and 6 or less.

<Ink Jet Recording Medium and Production Method Thereof>

A production method of an ink jet recording medium of the invention is a production method of an ink jet recording medium having a substrate and an ink receiving layer provided on the above-mentioned substrate, which method is characterized by comprising the step of forming a coated layer by applying the above-mentioned coating liquid for an ink receiving layer of the invention (hereinafter, occasionally referred to as a first liquid) on the above-mentioned substrate. An ink jet recording medium of the invention is produced by a production method of an ink jet recording medium of the invention.

(Substrate)

Either transparent substrates made of transparent materials such as plastics, or opaque substrates made of opaque materials such as paper sheets may be used as the substrate of the invention. The transparent substrate or highly glossy opaque substrate is preferably used for taking advantage of transparency of the ink receiving layer. Alternatively, read-only optical disks such as CD-ROM and DVD-ROM, write-once optical disks such as CD-R and DVD-R, and rewritable optical disks may be used as the substrate with the ink receiving layer applied at the labeling face side.

The materials used for the transparent substrate are preferably transparent and resistant to radiant heat generated suffered in uses in an OHP and backlight display. The preferable materials thereof include polyesters such as polyethylene terephthalate; polysulfone, polyphenylene oxide, polyimide, polycarbonate and polyamide. Polyesters are preferable, and polyethylene terephthalate is particularly preferable among them.

While the thickness of the substrate is not particularly restricted, it is preferably 50 to 200 μm from the viewpoint of handling performance.

The opaque substrate having high glossiness preferably has a glossiness of 40% or more. The glossiness is measured according to a 75 degree specular glossiness test method of paper sheets and paper board (JIS P-8142). Specific examples of the substrate are as follows.

They are, for example, highly glossy paper substrates such as art paper, coat paper, cast-coat paper, and barite paper used for silver salt photographic substrate; highly glossy films made to be opaque by adding a white pigment and the like in plastic films such as polyesters such as polyethylene terephthalate (PET), cellulose esters such as nitrocellulose, cellulose acetate and cellulose acetate butylate, polysulfone, polyphenylene oxide, polyimide, polycarbonate and polyamide (a calender treatment may be applied on the surface); and substrates having coated layers of polyolefin containing or not containing the white pigment on the surfaces of the various paper substrates, transparent substrates and highly glossy films containing the white pigment.

Foamed polyester films containing the white pigment (for example foamed PET that contains polyolefin fine particles, and in which voids are formed by stretching) are also favorably used. Resin coat paper used for the silver salt photographic printing paper is also favorably used.

While the thickness of the opaque substrate is not particularly restricted, it is preferably 50 to 300 μm considering handling performance.

A corona discharge treatment, glow discharge treatment, flame treatment or UV irradiation treatment may be applied on the surface of the substrate for improving wettability and adhesive property.

The raw paper sheet used for resin coat paper will be described in detail below.

The raw paper is produced using a wood pulp as a major material, and by adding a synthetic pulp such as polypropylene pulp, or synthetic fibers such as nylon or polyester fibers, into the wood pulp, if necessary. While any one of LBKP, LBSP, NBKP, NBSP, LDP, NDP, LUKP and NUKP may be used as the wood pulp, LBKP, NBSP, LBSP, NDP and LDP abundant in short fibers are preferably used.

However, the proportion of LBS and/or LDP is preferably 10% by mass or more and 70% by mass or less.

Chemical pulps (sulfate pulp and sulfite pulp) containing few impurities are preferably used, and the pulp having improved brightness by applying a bleaching treatment is also useful.

A sizing agent such as a higher fatty acid and alkylketene dimer; white pigment such as calcium carbonate, talc and titanium oxide; a paper strength enhancer such as starch, polyacrylamide and polyvinyl alcohol; a fluorescent brightener; a humectant such as polyethyleneglycol; a dispersing agent; and a softening agent such as quaternary ammonium may be appropriately added in the raw paper sheet.

About the freeness of the pulp used in papermaking, the value according to the rule of CSF is preferably from 200 to 500 ml. About the fiber length after beating, the sum of the mass percentage of a 24-mesh residue and the mass percentage of a 42-mesh residue, which are defined in JIS P-8207, is preferably from 30 to 70%. The mass percentage of a 4-mesh residue is preferably 20% or less.

The grammage (basic weight) of the base paper is preferably from 30 to 250 g, more preferably from 50 to 200 g. The thickness of the base paper is preferably from 40 to 250 μm. A high smoothness can be given to the base paper by subjecting the base paper to calendar treatment during or after the papermaking thereof. The density of the base paper is generally from 0.7 to 1.2 g/cm² (JIS P-8118).

The rigidity of the base paper is preferably from 20 to 200 g under conditions prescribed in JIS P-8143.

A surface sizing agent may be applied on the surface of the raw paper sheet, and the same sizing agent as added in the raw paper sheet may be used as the surface sizing agent.

The pH of the raw paper sheet is preferably 5 to 9 as measured by a hot water extraction method according to JIS P-8113.

While polyethylene used for coating the surface and back face of the raw paper sheet is low density polyethylene (LDPE) and/or high density polyethylene (HDPE), LLDPE, polypropylene and the like may be partly used.

Titanium oxide of rutile or anatase type, fluorescent whitener and ultramarine blue are preferably added into the polyethylene layer that forms the ink receiving layer to improve opaqueness, whiteness, and hue, as widely adopted in photographic printing paper sheets. The content of titanium oxide is preferably 3 to 20% by mass, more preferably 4 to 13% by mass, relative to polyethylene. While the thickness of the polyethylene layer is not particularly restricted, a thickness of 10 to 50 μm is favorable for both the top and back surface layers. An undercoat layer may be provided on the polyethylene layer for endowing the polyethylene layer with an adhesive property to the ink receiving layer. Aqueous polyester, gelatin and PVA are preferably used as the undercoat layer. The thickness of the undercoat layer is preferably 0.01 to 5 μm.

The polyethylene coated paper sheet may be used as glossy paper, or by forming a matte surface or silky surface that are obtainable in usual photographic printing paper sheets by applying an embossing treatment when polyethylene is coated on the raw paper sheet by melt-extrusion.

A back coat layer may be provided on the substrate, and examples of the components capable of adding to the back coat layer include a white pigment, aqueous binder and the like.

Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, ritpon, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cation starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include defoaming agents, foaming suppressing agents, dyes, fluorescent brighteners, antiseptics and water-proofing agent.

The ink receiving layer coating liquid (the first liquid) can be applied by a known coating method using an extrusion die coater, air doctor coater, blade coater, rod coater, knife coater, squeeze coater, reverse roll coater and bar coater.

An ink receiving layer according to an ink jet recording medium of the invention is formed in such a manner that a coated layer is formed by applying a coating liquid for an ink receiving layer according to the invention on a substrate to thereafter perform heat drying treatment as required, which ink receiving layer is preferably formed through the step of cross-linking and curing the above-mentioned coated layer by providing a basic coating liquid containing a basic compound (hereinafter, occasionally referred to as a second liquid) for the coated layer, either (1) simultaneously with the application of the above-mentioned coating liquid for an ink receiving layer or (2) before the above-mentioned coated layer exhibits decreasing rate of drying during the drying of the above-mentioned coated layer.

The formation of an ink receiving layer thus cross-linked and cured is preferable from the viewpoint of ink absorption, crack prevention of the layer and the like.

In such a manner as described above, most of the mordant exists near a surface of the ink receiving layer, whereby it is preferable that coloring materials of the ink jet are so sufficiently mordanted as to improve water resistance of letters and images after printing.

The second liquid may contain a cross-linking agent and other mordant components if necessary. The hardening of the layer can be accelerated by using the second liquid that is an alkaline solution. The second liquid is preferably adjusted to a pH of 7.1 or more, more preferably a pH of 7.5 or more, and most preferably a pH of 7.9 or more. When the pH is too near an acid side, the cross-linking reaction of the water-soluble polymer included in the first liquid does not performed sufficiently by the cross-linking agent, and thereby bronzing and the defect due to the crack or the like may be caused in the ink receiving layer.

For instance, the second liquid can be prepared by adding a metal compound (for instance, 1 to 5%), a basic compound (for instance, 1 to 5%), and, if necessary, para-toluene sulfonic acid (for instance, 0.5 to 3%) to the ion-exchange water, and by stirring the resultant mixture sufficiently. The term “%” in each composition refers to solid mass.

The phrase “before the coated layer exhibits a decreasing rate of drying” as used herein usually means a lapse of time of several minutes from immediately after application of the ink receiving layer coating liquid. The “constant rate drying” phenomenon in which the content of the solvent (dispersion medium) in the applied coated layer is reduced in proportion to the lapse of time appears during this period. The period exhibiting the “constant rate drying” is described in Kagaku Kogaku Binran (Handbook of Chemical Engineering; pp. 707-712, Maruzen Co., Ltd., Oct. 25, 1980).

While the ink receiving layer is dried until the coated layer exhibits a decreasing rate of drying after applying the first coating liquid, this drying period is usually 0.5 to 10 minutes (preferably 0.5 to 5 minutes) at 40 to 180° C. Although the drying period is naturally different depending on the amount of coating, the range above is usually appropriate.

Examples of the method available for applying the second coating liquid before the first coated layer exhibits a decreasing rate of drying include (1) a method for additionally applying the second coating liquid on the coated layer, (2) a spraying method, and (3) a method for dipping the substrate comprising the coated layer thereon in the second coating liquid.

The method available for applying the second coating liquid in the method (1) include the methods known in the art using a curtain flow coater, extrusion die coater, air doctor coater, blade coater, rod coater, knife coater, squeeze coater, reverse roll coater and bar coater. However, the methods using the extrusion die coater, curtain flow coater and bar coater are preferable since these methods are able to apply without making no direct contact on the already formed first coated layer.

The ink receiving layer is usually heated at 40 to 180° C. for 0.5 to 30 minutes for drying and hardening after applying the second coating liquid. Heating at 40 to 150° C. for 1 to 20 minutes is particularly preferable.

When the second coating liquid is applied at substantially the same time of applying the coating liquid for the ink receiving layer (the first coating liquid), the first and second coating liquid are simultaneously applied (dual layer application) on the substrate so that the first coating liquid contacts the substrate, followed by forming the ink receiving layer by hardening by drying thereafter.

Above-described simultaneous application (dual layer application) can be performed by the coating method using the extrusion die coater, the curtain flow coater, and the like. While the coated layer formed is dried after the simultaneous application, the layer is usually dried by heating at 40 to 150° C. for 0.5 to 10 minutes, preferably at 40 to 100° C. for 0.5 to 5 minutes.

When the coating liquids are applied so as to form a dual layer with the extrusion die coater, for example, the dual layer is formed in the vicinity of the discharge port of the extrusion die coater by simultaneously discharging the two kinds of the coating liquids before being transferred onto the substrate, in order to directly form the dual coated layer. Since the two kinds of the coating liquids in the dual layer before application tends to form cross-links at the interface between the two solutions before being transferred onto the substrate, the two solutions are liable to be thickened by being mixed with each other in the vicinity of the discharge port of the extrusion die coated. Consequently, the application work may be difficult. Accordingly, it is preferable to simultaneously form a triple layer by permitting a barrier layer solution (an intermediate layer solution) to interpose between the two coating liquids.

The barrier layer solution may be selected without any restrictions including, for example, an aqueous solution containing a trace amount of an water soluble resin and water. The water soluble resin is added as a thickener for improving coating performance. Examples of the water soluble resin include cellulose resins (such as hydroxylpropylmethyl cellulose, methyl cellulose and hydroxyethyl cellulose), polyvinyl pyrrolidone and gelatin. The dye mordant may be added to the barrier layer solution.

The surface smoothness, glossiness, transparency and coated layer strength may be improved by applying a calender treatment by passing the sheet through roll nips by heating with compression using a super calender or gloss calender machine after forming the ink receiving layer is formed on the substrate. However, since the calender treatment may cause a decrease of the void ratio (or decrease or ink absorbing property), a condition giving small decrease of the void ratio should be employed.

The roll temperature for applying the calender treatment is preferably 30 to 150° C., more preferably 40 to 110° C.

The linear pressure between the rolls for calender treatment is preferably 50 to 400 kg/cm, more preferably 100 to 200 kg/cm.

Since the ink receiving layer is required to have a thickness that renders an absorption capacity enough for absorbing all the droplets in the ink-jet recording, the thickness should be determined in relation to the void ratio in the layer. For example, the thickness should be about 15 μm or more when the amount of the ink is 8 nL/mm2 and the void ratio is 60%.

The thickness of the ink receiving layer is preferably 10 to 50 μm for ink-jet recording considering the conditions above.

The diameter of the void in the ink receiving layer is preferably 0.005 to 0.030 μm, more preferably 0.01 to 0.25 μm, in a median diameter.

The void ratio and median diameter can be measured using a mercury porosimeter (trade name: Poresizer 9320-PC2, manufactured by Shimadzu Corporation).

The pH of the surface of the ink receiving layer of the invention is preferably 3 or more and 6 or less, more preferably 3.5 or more and 4.5 or less. The pH on the surface is measured 30 seconds after dripping distilled water according to the J. TAPPI Paper and Pulp Test Method No. 49. Image preservability is improved when the pH is 3 or more, while water resistance is improved when the pH is 6 or less to enable bleeding under a high temperature high humidity condition to be suppressed. Accordingly, resistance to bleeding over time, ozone resistance and light fastness may be improved when the pH of the surface is 3 or more and 6 or less.

While it is preferable that the ink receiving layer is excellent in transparency, the criterion of transparency is that the ink receiving layer formed on a transparent film substrate preferably has a haze value of 20 or less, more preferably 15 or less.

A Dispersion of polymer fine particles may be added to the constituting layers of the ink jet recording medium of the invention (for example the ink receiving layer or back layer). This polymer fine particle dispersion is used for improving film properties such as dimensional stability, curl prevention property, adhesion prevention property and crack prevention property. The polymer fine particle dispersion is described in JP-A Nos. 62-245258, 62-1316648 and 62-110066. Cracking and curling of the layer can be prevented by adding a polymer fine particle dispersion having a low glass transition temperature (40° C. or less) in the layer for ink receiving. Curling may be also prevented by adding a polymer fine particle dispersion having a high glass transition temperature to the back layer.

### EXAMPLES

Hereinbelow, the present invention is described in detail with reference to examples, the invention is by no means restricted to these examples. “Parts” and “%” in the examples mean “parts by mass” and “% by mass” unless otherwise stated.

### Example 1

—Preparation of Support—

50 parts of LBKP composed of acacia and 50 parts of LBKP composed of aspen were each beaten into 300 ml of Canadian freeness by a disc refiner to prepare pulp slurry.

Next, to the pulp slurry, cationic starch (trade name: CATO 304L, produced by Nippon NSC, Ltd.) of 1.3%, anionic polyacrylamide (trade name: DA4104, produced by SEIKO PMC CORPORATION) of 0.15%, alkylketenedimer (trade name: Sizepine K, produced by Arakawa chemical Industries, Ltd.) of 0.29%, epoxidized behenic acid amide of 0.29%, and polyamide polyamine epichlorohydrin (trade name: Arafix 100, produced by Arakawa Chemical Industries, Ltd.) of 0.32% were added. A defoaming agent of 0.12% was then added to the resultant mixture.

The pulp slurry prepared in such a manner as described above was made into paper by a Fourdrinier paper machine, and a felt side of the web was dried by determining a tensile force of dryer canvas at 1.6 kg/cm in the step of drying by pushing against a drum dryer cylinder through the dryer canvas. Thereafter,

Polyvinyl alcohol (trade name: KL-118, produced by Kuraray Co., Ltd.) of 1 g/m² was coated on both surfaces of a base paper by a size press, and dried. A calender treatment was then performed to obtain a base paper sheet. The basis weight of the base paper was 166 g/m², and the thickness of the base paper sheet was 160 μm.

The wire face (back face) of the obtained base paper sheet was subjected to corona discharge treatment and thereafter coated with high-density polyethylene up to a thickness of 25 μm by using a melt extruder to form a thermoplastic resin layer composed of the mat face (hereinafter, this thermoplastic resin layer face was referred to as “back face”). The thermoplastic resin layer on this back face was further subjected to corona discharge treatment and thereafter coated with dispersion as an antistatic agent up to a dry mass of 0.2 g/m², in which aluminum oxide (trade name: ALUMINASOL 100, manufactured by Nissan Chemical Industries, Ltd.) and silicon dioxide (trade name: SNOWTEX O, manufactured by Nissan Chemical Industries, Ltd.) were dispersed in water at a mass ratio of 1:2, to obtain a substrate.

—Preparation of Coating Liquid for Ink Receiving Layer—

[1] Gas phase silica fine particles, [2] ion-exchange water, [3] trade name: SHALLOL DC-902P, [4] trade name: ZA-30 and [5] methionine sulfoxide in the following composition were mixed and dispersed by using a liquid-liquid collision type disperser (trade name: ULTIMAIZER, manufactured by Sugino Machine Limited), and thereafter the dispersion was heated to a temperature of 45° C. and retained for 20 hours to prepare silica dispersion.

Thereafter, the following [6] boric acid, [7] trade name: SC-505, [8] polyvinyl alcohol solution, [9] trade name: SUPERFLEX 650 and [10] ethanol were added to this silica dispersion at a temperature of 30° C. to prepare a coating liquid for an ink receiving layer A.

The mass ratio (PB ratio=[1]:[8]) of the silica fine particles and the water soluble binder was 4.45:1 and the pH of the coating liquid for an ink receiving layer A was 3.8 which denoted acidity.

<Composition of coating liquid for ink receiving layer A>

| | |
|---|---|
| [1] Gas phase silica fine particles | 8.9 parts |
| (trade name: AEROSIL300SF75, manufactured | |
| by Nippon Aerosil Co., Ltd.) | |
| [2] Ion-exchange water | 52.2 parts |
| [3] Trade name: SHALLOL DC-902P | 0.78 parts |
| (51.5%-aqueous solution) (dispersant, | |
| manufactured by Dai-ichi Kogyo Seiyaku Co., Ltd.) | |
| [4] Trade name: ZA-30 | 0.48 parts |
| (manufactured by Daiichi Kigenso Kagaku | |
| Kogyo Co., Ltd.) | |
| [5] Methionine sulfoxide | 0.7 parts |
| [6] Boric acid (cross-linking agent) | 0.4 parts |
| [7] Trade name: SC-505 (manufactured by Hymo Co., Ltd.) | 0.23 parts |
| [8] Polyvinyl alcohol (water soluble binder) solution | 31.2 parts |
| [9] Trade name: SUPERFLEX 650 | 2.2 parts |
| (manufactured by Dai-ichi Kogyo Seiyaku Co., Ltd.) | |
| [10] Ethanol | 1.2 parts |

<Composition of polyvinyl alcohol solution>

| | |
|---|---|
| trade name: PVA 235, manufactured by Kuraray | 2.2 parts |
| Co., Ltd., saponification degree of | |
| 88%, polymerization degree of 3500 | |
| ion-exchange water | 28.2 parts |
| diethylene glycol monobutyl ether (trade | 0.7 parts |
| name: BUTYCENOL 20P, manufactured by | |
| Kyowa Hakko Chemical Co., Ltd.) | |
| trade name: EMULGEN 109P (manufactured | 0.1 parts |
| by Kao Corporation) | |

—Preparation of Ink Jet Recording Medium—

The front face of the above-mentioned substrate was subjected to corona discharge treatment to thereafter pour the coating liquid for an ink receiving layer A thereon up to 173 cc/m², which coating liquid was in-line coated with the following in-line liquid at a rate of 10.8 cc/m². The substrate was dried by a hot-air dryer at a temperature of 80° C. (wind speed of 3 to 8 m/second) until the solid content concentration of the coated layer became 24%. This coated layer exhibited constant drying rate in the meantime. Immediately thereafter, the substrate was immersed in a second liquid of the following composition for 3 seconds, which second liquid adhered to the above-mentioned coated layer by 13 g/m², and further dried at a temperature of 72° C. for 10 minutes. Thus, an ink jet recording medium of the invention, which was provided with an ink receiving layer having a dried film thickness of 32 μm, was prepared.

<Composition of in-line liquid>

| | |
|---|---|
| [1] Trade name: ALUFINE 83 | 2.0 parts |
| (manufactured by Taimei Chemicals Co., Ltd.) | |
| [2] Ion-exchange water | 8.0 parts |

<Composition of second liquid>

| | |
|---|---|
| [1] Boric acid | 0.65 parts |
| [2] Ammonium carbonate (primary: | 5.0 parts |
| manufactured by Kanto Chemical Co., Inc.) | |
| [3] ZIRCOSOL AC-7 | 2.5 parts |
| [4] Ion-exchange water | 85.8 parts |
| [5] Polyoxyethylene lauryl ether (surface-active | 6.0 parts |
| agent) | |
| (trade name: EMULGEN 109P (10%-aqueous | |
| solution), manufactured by Kao | |
| Corporation, HLB value of 13.6) | |

### Example 2

An ink jet recording medium was prepared in the same manner as Example 1 except for adding methionine (manufactured by Tokyo Chemical Industry Co., Ltd.) instead of methionine sulfoxide in the coating liquid for an ink receiving layer A of Example 1.

### Example 3

An ink jet recording medium was prepared in the same manner as Example 1 except for adding L-cysteine (manufactured by Tokyo Chemical Industry Co., Ltd.) instead of methionine sulfoxide in the coating liquid for an ink receiving layer A of Example 1.

### Example 4

An ink jet recording medium was prepared in the same manner as Example 1 except for adding glycine (manufactured by Tokyo Chemical Industry Co., Ltd.) instead of methionine sulfoxide in the coating liquid for an ink receiving layer A of Example 1.

### Example 5

An ink jet recording medium was prepared in the same manner as Example 1 except for adding serine (manufactured by Kanto Chemical Co., Inc.) instead of methionine sulfoxide in the coating liquid for an ink receiving layer A of Example 1.

### Example 6

An ink jet recording medium was prepared in the same manner as Example 1 except for adding leucine (manufactured by Kanto Chemical Co., Inc.) instead of methionine sulfoxide in the coating liquid for an ink receiving layer A of Example 1.

### Comparative Example 1

An ink jet recording medium was prepared in the same manner as Example 1 except for not adding methionine sulfoxide in the coating liquid for an ink receiving layer A of Example 1.

### Comparative Example 2

An ink jet recording medium was prepared in the same manner as Example 1 except for adding methionine sulfoxide after being heated to a temperature of 45° C. and retained for 20 hours in the coating liquid for an ink receiving layer A of Example 1.

### Comparative Example 3

An ink jet recording medium attempted to be prepared in the same manner as Example 1 except for adding glutamic acid (manufactured by Kanto Chemical Co., Inc.) instead of methionine sulfoxide in the coating liquid for an ink receiving layer A of Example 1; however, an ink jet recording medium could not be prepared for the reason that the viscosity of the coating liquid for an ink receiving layer was increased.

### Comparative Example 4

An ink jet recording medium was prepared in the same manner as Example 1 except for adding L-cysteine (manufactured by Tokyo Chemical Industry Co., Ltd.) after being heated to a temperature of 45° C. and retained for 20 hours instead of the addition of methionine sulfoxide in the coating liquid for an ink receiving layer A of Example 1.

### Comparative Example 5

An ink jet recording medium attempted to be prepared in the same manner as Example 1 except for adding glycine (manufactured by Tokyo Chemical Industry Co., Ltd.) after being heated to a temperature of 45° C. and retained for 20 hours instead of the addition of methionine sulfoxide in the coating liquid for an ink receiving layer A of Example 1; however, an ink jet recording medium could not be prepared for the reason that the viscosity of the coating liquid for an ink receiving layer was increased.

The following evaluations were performed for the obtained coating liquid for an ink receiving layer and ink jet recording medium. The obtained results are shown in Tables 1 and 2.

—Coating Liquid Viscosity Evaluation Method—

The coating liquid for an ink receiving layer one day after preparation was measured by a Brookfield type viscometer and determined as follows.

A: 150 mPa·S or less

B: 150 to 250 mPa·S

C: 250 to 500 mPa·S

D: 500 mPa·S or more

—Coated Surface State Evaluation Method—

The surface cracks of the ink jet recording medium after application was visually determined as follows.

A: no cracks

B: a few cracks were observed

C: many cracks were observed

—Ozone Resistance Evaluation Method—

A solid image in magenta was printed on each ink jet recording medium by using an ink jet printer (trade name: PMG-800, manufactured by Seiko Epson Corporation) mounted with genuine ink sets, and the samples were stored for 48 hours in such an atmosphere as 23° C., 60% RH and an ozone concentration of 10 ppm. The magenta concentration was measured by a reflection densitometer (trade name: XRITE 938, manufactured by X-Rite, Incorporated.), and residual rate was calculated from cyan concentration before storage and cyan concentration after storage on the basis of the following expression to determine on the basis of the following standard.

Residual rate (%)=(cyan concentration after storage/cyan concentration before storage)×100

A: 65% or more

B: 55 to 65%

C: 55% or less

TABLE 1

| | Example 1 | Example 2 | Example 3 | Example 4 | Example 5 | Example 6 |
|---|---|---|---|---|---|---|
| Amino acid | Methionine | Methionine | L-cysteine | Glycine | Serine | Leucine |
| | sulfoxide | | | | | |
| Carboxylic | Monovalent | → | → | → | → | → |
| acid | | | | | | |
| Addition | Before | → | → | → | → | → |
| method | dispersion | | | | | |
| Coating | A | B | B | B | B | B |
| liquid | | | | | | |
| viscosity | | | | | | |
| Ozone | A | A | A | B | B | B |
| resistance | | | | | | |
| Surface state | A | A | A | A | A | A |

TABLE 2

| | Compar- | | Compar- | Compar- | Compar- |
|---|---|---|---|---|---|
| | ative | Comparative | ative | ative | ative |
| | Example 1 | Example 2 | Example 3 | Example 4 | Example 5 |
| Amino | None | Methionine | Glutamic | L-cysteine | Glycine |
| acid | | sulfoxide | acid | | |
| Carbox- | — | Monovalent | Divalent | Mono- | → |
| ylic acid | | | | valent | |
| Addition | — | After | Before | After | → |
| method | | dispersion | dispersion | dispersion | |
| Coating | C | C | D | C | D |
| liquid | | | | | |
| viscosity | | | | | |
| Ozone | C | A | — | A | — |
| resistance | | | | | |
| Surface | A | A | — | B | — |
| state | | | | | |

It was understood from Tables 1 and 2 that the dispersion of a mixed liquid containing silica fine particles synthesized by a gas phase method and an amino acid having one carboxyl group in a molecule allowed a coating liquid having low viscosity to be prepared and an ink jet recording medium prepared by the coating liquid was favorable in ozone resistance and surface state.

The invention can provide a production method of a coating liquid for an ink receiving layer, capable of suppressing viscosity increase, a coating liquid for an ink receiving layer obtained by the method, an ink jet recording medium using this coating liquid, and a production method thereof.

That is to say, the invention is as follows:

(1) A production method of a coating liquid for an ink receiving layer characterized in that a water soluble binder is added to silica dispersion obtained by dispersing a mixed liquid containing silica fine particles synthesized by a gas phase method and an amino acid having one carboxyl group in a molecule;

(2) The production method of a coating liquid for an ink receiving layer of (1), characterized in that the above-mentioned amino acid contains a sulfur atom;

(3) The production method of a coating liquid for an ink receiving layer of (1), characterized in that the above-mentioned water soluble binder is polyvinyl alcohol-based resin;

(4) The production method of a coating liquid for an ink receiving layer of (1), characterized in that an average primary particle diameter of the above-mentioned silica fine particles is 1 to 20 nm;

(5) The production method of a coating liquid for an ink receiving layer of (1), characterized in that a cross-linking agent capable of cross-linking the above-mentioned water soluble binder is further added to the above-mentioned silica dispersion;

(6) The production method of a coating liquid for an ink receiving layer of (5), characterized in that the above-mentioned cross-linking agent is a boric acid;

(7) A coating liquid for an ink receiving layer produced by the production method of a coating liquid for an ink receiving layer of any of (1) to (6);

(8) A production method of an ink jet recording medium having a substrate and an ink receiving layer provided on the above-mentioned substrate, characterized by comprising the step of forming a coated layer by applying the coating liquid for an ink receiving layer of (7) on the above-mentioned substrate;

(9) The production method of an ink jet recording medium of (8), characterized by further comprising the step of cross-linking and curing the above-mentioned coated layer by providing a basic coating liquid containing a basic compound for the coated layer, either (1) simultaneously with the application of the above-mentioned coating liquid for an ink receiving layer or (2) before the coated layer exhibits decreasing rate of drying during the drying of the above-mentioned coated layer; and

(10) An ink jet recording medium produced by the production method of an ink jet recording medium of (8) or (9).

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the preferred embodiments of the present invention. The scope of the invention, therefore, should be determined by the following claims.

What is claimed is:

1. A production method of a coating liquid for an ink receiving layer, the production method comprising:
dispersing in a liquid at least silica fine particles synthesized by a gas phase method and an amino acid having only one carboxyl group per molecule, to obtain a silica dispersion;
adding a water soluble binder to the silica dispersion.

2. The production method of a coating liquid for an ink receiving layer of claim 1, wherein the amino acid further comprises a sulfur atom.

3. The production method of a coating liquid for an ink receiving layer of claim 1, wherein the water soluble binder is a polyvinyl alcohol-based resin.

4. The production method of a coating liquid for an ink receiving layer of claim 1, wherein an average primary particle diameter of the silica fine particles is 1 to 20 nm.

5. The production method of a coating liquid for an ink receiving layer of claim 1, further comprising adding a cross-linking agent capable of cross-linking the water soluble binder to the silica dispersion.

6. The production method of a coating liquid for an ink receiving layer of claim 5, wherein the cross-linking agent is boric acid.

7. A coating liquid for an ink receiving layer comprising: a water soluble binder added to a silica dispersion obtained by dispersing at least silica fine particles synthesized by a gas phase method and an amino acid having only one carboxyl group per molecule in a liquid.

8. The coating liquid for an ink receiving layer of claim 7, wherein the amino acid further comprises a sulfur atom.

9. The coating liquid for an ink receiving layer of claim 7, wherein the water soluble binder is a polyvinyl alcohol-based resin.

10. The coating liquid for an ink receiving layer of claim 7, wherein an average primary particle diameter of the silica fine particles is 1 to 20 mm.

11. The coating liquid for an ink receiving layer of claim 7, further comprising a cross-linking agent capable of cross-linking the water soluble binder added to the silica dispersion.

12. The coating liquid for an ink receiving layer of claim 11, wherein the cross-linking agent is boric acid.

13. A production method of an ink jet recording medium having a substrate and an ink receiving layer provided on the substrate, the production method comprising:
dispersing at least silica fine particles synthesized by a gas phase method and an amino acid having only one carboxyl group per molecule in a liquid to form a silica dispersion;
adding a water soluble binder to the silica dispersion to form a coating liquid for an ink receiving layer; and
applying the coating liquid onto the substrate, forming an ink receiving coated layer.

14. The production method of an ink jet recording medium of claim 13, wherein the amino acid further comprises a sulfur atom.

15. The production method of an ink jet recording medium of claim 13, wherein the water soluble binder is a polyvinyl alcohol-based resin.

16. The production method of an ink jet recording medium of claim 13, wherein an average primary particle diameter of the silica fine particles is 1 to 20 nm.

17. The production method of an ink jet recording medium of claim 13, further comprising adding a cross-linking agent capable of cross-linking the water soluble binder to the silica dispersion.

18. The production method of an ink jet recording medium of claim 17, wherein the cross-linking agent is boric acid.

19. The production method of an ink jet recording medium of claim 13, further comprising: cross-linking and curing the coated layer by applying a basic coating liquid containing a basic compound to the coated layer, either (1) simultaneously with the application of the coating liquid for an ink receiving layer or (2) before the coated layer exhibits a decreasing rate of drying during drying of the coated layer.

20. An ink jet recording medium having a substrate and an ink receiving layer provided on the substrate, the ink jet recording medium comprising a coated layer formed by applying onto the substrate a coating liquid for an ink receiving layer, wherein the coating liquid comprises a silica dispersion obtained by dispersing at least silica fine particles synthesized by a gas phase method and an amino acid having only one carboxyl group per molecule in a liquid, to which a water soluble binder has been added.

21. The ink jet recording medium of claim 20, wherein the amino acid further comprises a sulfur atom.

22. The ink jet recording medium of claim 20, wherein the water soluble binder is a polyvinyl alcohol-based resin.

23. The ink jet recording medium of claim 20, wherein an average primary particle diameter of the silica fine particles is 1 to 20 nm.

24. The ink jet recording medium of claim 20, wherein the coating liquid further comprises a cross-linking agent capable of cross-linking the water soluble binder added to the silica dispersion.

25. The ink jet recording medium of claim 24, wherein the cross-linking agent is boric acid.

26. The ink jet recording medium of claim 20, wherein the coated layer has been cross-linked and cured by further applying a basic coating liquid containing a basic compound to the coated layer, either (1) simultaneously with the application of the coating liquid for an ink receiving layer or (2) before the coated layer exhibits a decreasing rate of drying during drying of the coated layer.
